(19) United States
(12) Patent Application Publication
(10) Pub. No.: US 2016/0070118 A1
(43) Pub. Date: Mar. 10, 2016

(54) Eyewear Assembly with Pivotal Lenses

(71) Applicant: Robert Caggiano, Nahant, MA (US)

(72) Inventor: Robert Caggiano, Nahant, MA (US)

(21) Appl. No.: 14/482,189

(22) Filed: Sep. 10, 2014

(51) Int. Cl. G02C 7/08; G02C 5/22; G02C 9/02

(52) U.S. Cl. CPC G02C 7/088; G02C 9/02; G02C 5/22

(57) ABSTRACT

An eyewear assembly with pivotal lenses allows the lenses to be pivoted and interchanged as needed to ensure that desired lenses are readily accessible. The assembly includes a frame having a pair of temples and a front. The front is coupled to and extends between the pair of temples. A lens assembly is provided and includes a first pair of lenses. Each of the lenses of the first pair of lenses is pivotally coupled to the front of the frame to allow the lenses of the first pair of lenses to be pivoted toward and away from the front of the frame.

### BACKGROUND OF THE DISCLOSURE

Field of the Disclosure

The disclosure relates to eyewear assemblies and more particularly pertains to a new eyewear assembly for allowing the lenses to be pivoted and interchanged as needed to ensure that desired lenses are readily accessible.

### SUMMARY OF THE DISCLOSURE

An embodiment of the disclosure meets the needs presented above by generally comprising a frame having a pair of temples and a front. The front is coupled to and extends between the pair of temples. A lens assembly is provided and includes a first pair of lenses. Each of the lenses of the first pair of lenses is pivotally coupled to the front of the frame to allow the first pair of lenses to be pivoted toward and away from the front of the frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of an eyewear assembly with pivotal lenses according to an embodiment of the disclosure.

FIG. 2 is a side view of an embodiment of the disclosure.

FIG. 3 is an exploded top front side perspective view of an embodiment of the disclosure.

FIG. 4 is a front view of an embodiment of the disclosure.

FIG. 5 is a front view of an embodiment of the disclosure showing the lenses of the first pair of lenses pivoted upwardly relative to the front of the frame.

FIG. 6 is a top view of an embodiment of the disclosure showing the lenses of the first pair of lenses pivoted upwardly relative to the front of the frame.

FIG. 7 is a front view of an alternative embodiment of the disclosure.

### DESCRIPTION OF THE PREFERRED EMBODIMENT

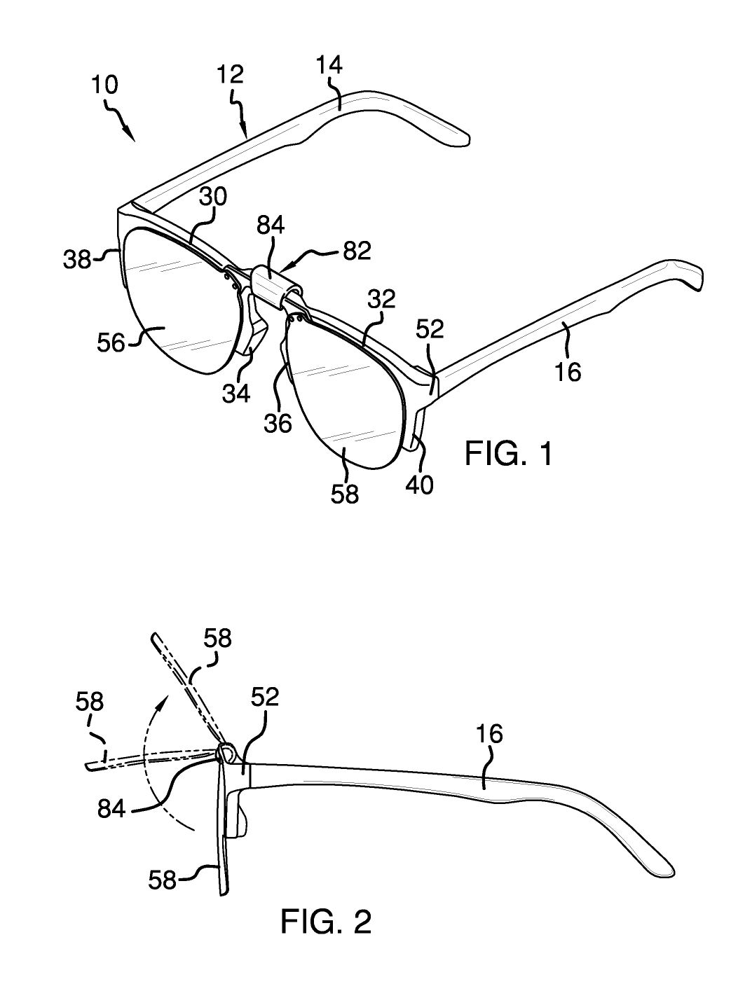

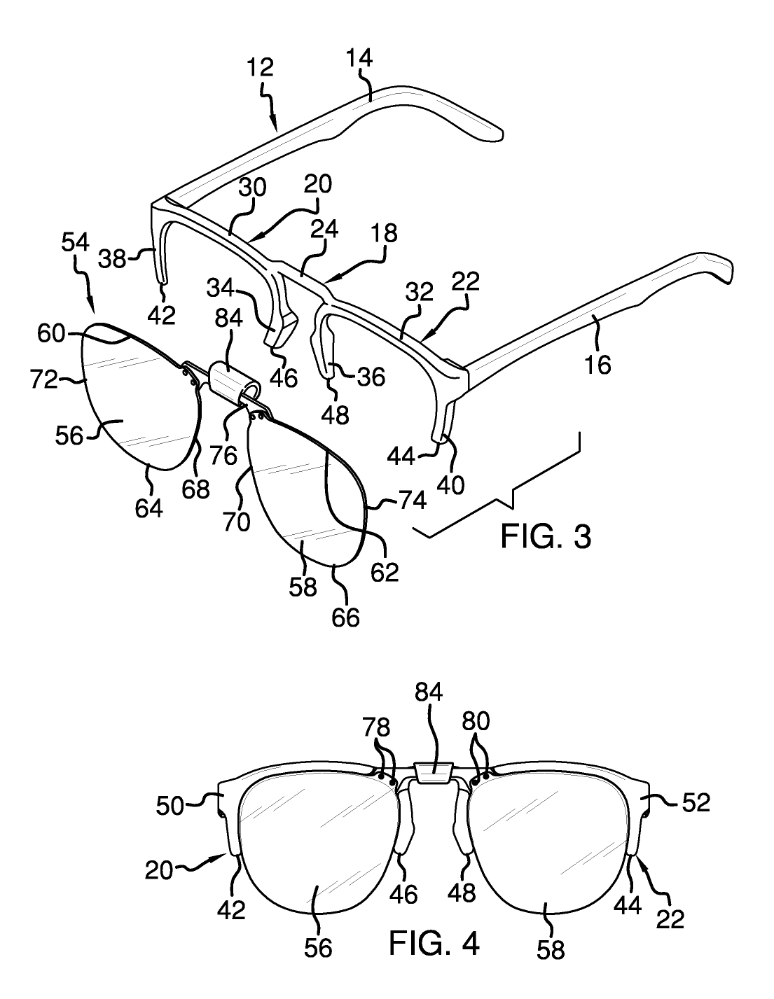

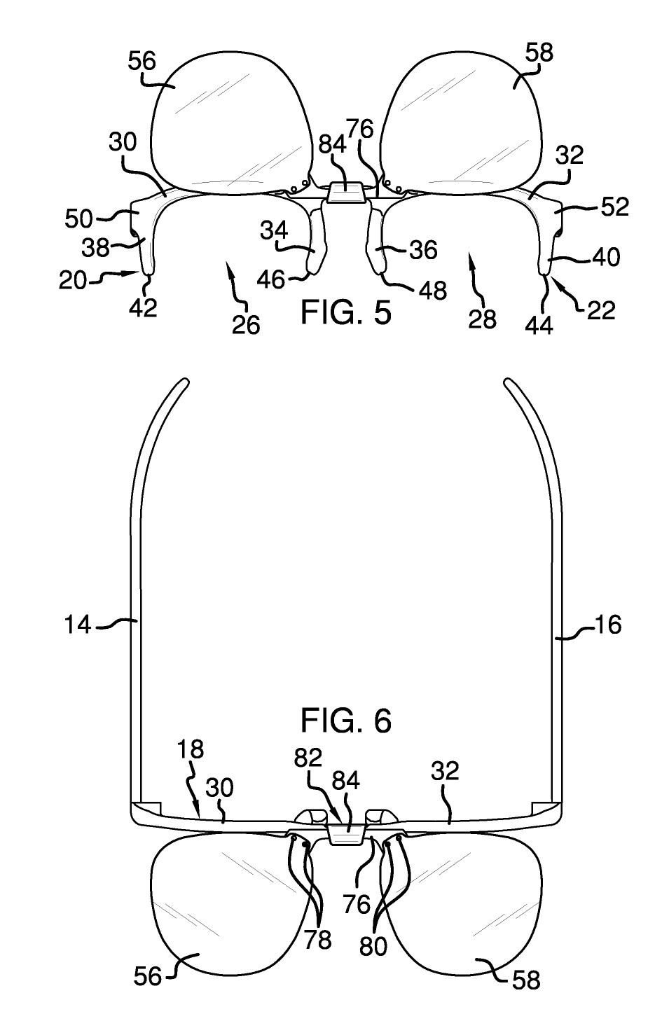

With reference now to the drawings, and in particular to FIGS. 1 through 7 thereof, a new eyewear assembly embodying the principles and concepts of an embodiment of the disclosure and generally designated by the reference numeral 10 will be described.

As best illustrated in FIGS. 1 through 7, the eyewear assembly with pivotal lenses 10 generally comprises a frame 12 that may be of conventional design. The frame 12 includes a pair of temples 14, 16 and a front 18 coupled to and extending between the pair of temples 14, 16. The temples 14, 16 may each be hingedly coupled to the front 18 to allow the temples 14, 16 to pivot inwardly toward the front 18 for storage of the temples 14, 16. The front 18 includes a pair of rims 20, 22 and a frame bridge 24 coupled to and extending between each of the rims 20, 22. The rims 20, 22 are spaced and horizontally aligned relative to each other. Each of the rims 20, 22 is coupled to an associated one of the temples 14, 16. Each of the rims 20, 22 may have a respective break 26, 28 extending therethrough. Each of the rims 20, 22 has a respective top section 30, 32, inner side section 34, 36 and outer side section 38, 40. Each of the top sections 30, 32 is coupled to and extends between the associated inner 34, 36 and outer side sections 38, 40. Each of the outer side sections 38, 40 has a proximal end 42, 44 with respect to the associated top section 30, 32. Similarly, each of the inner side sections 34, 36 has a lower end 46, 48 with respect to the associated top section 30, 32. Each of the breaks 26, 28 may extend between the proximal end 42, 44 and the lower end 46, 48 of the associated rim 20, 22. The frame 12 may further include a first end piece 50 and a second end piece 52 each coupled to and extending between an associated rim 20, 22 and an associated temple 14, 16. The frame 12 may be comprised of a rigid material, such as metal, plastic or the like.

A lens assembly 54 is provided that includes a first pair of lenses 56, 58. The first pair of lenses 56, 58 may comprise any type of lenses, such as prescription lenses, sunglass lenses, safety lenses or the like. Each of the first pair of lenses 56, 58 is pivotally coupled to the front 18 of the frame 12 to allow the first pair of lenses 56, 58 to be pivoted toward the front 18 of the frame 12 when needed and away from the front 18 of the frame 12 when not needed. In particular, each of the first pair of lenses 56, 58 may pivot upwardly relative to the front 18 of the frame 12. Each of the first pair of lenses 56, 58 may be removably coupled to the front 18 of the frame 12 whereby the first pair of lenses 56, 58 are interchangeable to allow the user to choose appropriate lenses for a particular occasion. Each of the first pair of lenses 56, 58 is positionable within an associated one of the rims 20, 22 such that the associated rim 20, 22 extends at least partially around the respective lens 56, 58 of the first pair of lenses 56, 58. Each of the first pair of lenses 56, 58 has an upper edge 60, 62, a lower edge 64, 66, an inner edge 68, 70 and an outer edge 72, 74.

A lens bridge 76 is coupled to and extends between each of the first pair of lenses 56, 58. The lens bridge 76 is coupled to the frame bridge 24. A pair of hinges 78, 80 may be provided wherein each of the hinges 78, 80 pivotally couples a respective one of the lenses 56, 58 of the first pair of lenses 56, 58 to the lens bridge 76 such that each of the first pair of lenses 56, 58 is pivotable independently of each other. Each of the hinges 78, 80 may be coupled to the respective lens 56, 58 at a juncture between the upper edge 60, 62 and the inner edge 68, 70 of the respective lens 56, 58 of the first pair of lenses 56, 58. A coupler 82 releasably couples the lens assembly 54 to the front 18 of the frame 12. The coupler 82 releasably couples the lens bridge 76 to the frame bridge 24 for attaching the first pair of lenses 56, 58 to the frame 12. The coupler 82 may comprise a clip 84.

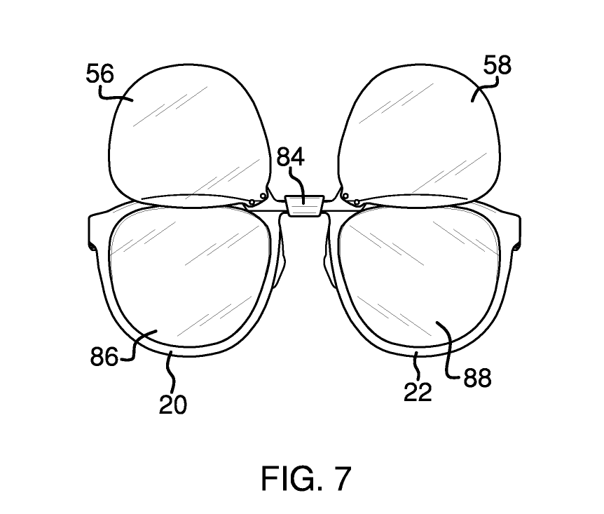

As shown in an alternative embodiment of FIG. 7, each of the lenses 56. 58 of the first pair of lenses 56, 58 may instead be positionable in front of an associated one of the rims 20, 22 when the lenses 56, 58 of the first pair of lenses 56, 58 are pivoted downwardly. This positioning allows a second pair of lenses 86, 88 to also be coupled to the frame 12. Each of the lenses 86, 88 of the second pair of lenses 86, 88 is positionable within, and coupled to, an associated one of the rims 20, 22. Each of the lenses 56, 58 of the first pair of lenses 56, 58 is positionable in front of an associated one of the second pair of lenses 86, 88 such that the lenses 56, 58 of the first pair of lenses 56, 58 extend over and cover the lenses 86, 88 of the second pair of lenses 86, 88. This allows two types of lenses to be used simultaneously. For instance, where the second pair of lenses 86, 88 is a prescription lens, the user can flip down the lenses 56, 58 of the first pair of lenses 56, 58 and additionally have safety lenses, sunglass lenses or any other type of lenses that the user desires.

In use, desired lenses are attached to the frame 12 using the coupler 82. When a user desires to use the first pair of lenses 56, 58, the lenses 56, 58 of the first pair of lenses 56, 58 are pivoted downwardly and positioned in front of the user's eyes. When not needed, the lenses 56, 58 of the first pair of lenses 56, 58 are pivoted upwardly above the rims 20, 22. In this manner, the assembly 10 allows the frame 12 to remain safely on the user's head while the lenses 56, 58 of the first pair of lenses 56, 58 are not being used. The lenses 56, 58 of the first pair of lenses 56, 68 can be interchanged as desired to provide eye protection, improved visual acuity or the like. The second pair of lenses 86, 88 may provide permanent lenses for the assembly 10 such that a person wearing the assembly 10 need only flip down the first pair of lenses 56, 58 to be able to look through both the first 56, 58 and second 86, 88 pairs of lenses.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An eyewear assembly with pivotal lenses comprising:
a frame having a pair of temples and a front, said front being coupled to and extending between said pair of temples; and
a lens assembly including a first pair of lenses, each of said lenses of said first pair of lenses being pivotally coupled to said front of said frame to allow said lenses of said first pair of lenses to be pivoted toward and away from said front of said frame.

2. The assembly of claim 1, further comprising wherein said front of said frame includes;
a pair of rims being spaced and horizontally aligned relative to each other, each of said rims being coupled to an associated one of said temples, each of said lenses of said first pair of lenses being positionable within an associated one of said rims such that said associated rim extends at least partially around said respective lens of said first pair of lenses; and
a frame bridge coupled to and extending between each of said rims.

3. The assembly of claim 1, further comprising a lens bridge coupled to and extending between each of said lenses of said first pair of lenses.

4. The assembly of claim 2, further comprising:
each of said lenses of said first pair of lenses being removably coupled to said front of said frame whereby said lenses of said first pair of lenses are interchangeable; and
a coupler releasably coupling said lens assembly to said front of said frame.

5. The assembly of claim 4, further comprising a lens bridge coupled to and extending between each of said lenses of said first pair of lenses, said coupler releasably coupling said lens bridge to said frame bridge for attaching said lenses of said first pair of lenses to said frame.

6. The assembly of claim 4, further comprising wherein said coupler comprises a clip.

7. The assembly of claim 2, further comprising wherein each of said rims has a respective break extending therethrough.

8. The assembly of claim 7, further comprising wherein each of said rims has a respective top section, inner side section and outer side section, each of said top sections being coupled to and extending between said associated inner and outer side sections, each of said outer side sections having a proximal end with respect to said associated top section, each of said inner side sections having a lower end with respect to said associated top section, each of said breaks extending between said proximal end and said lower end of said associated rim.

9. The assembly of claim 2, further comprising wherein said frame further includes a first end piece and a second end piece, each of said first and second end pieces being coupled to and extending between an associated said rim and an associated said temple.

10. The assembly of claim 1, further comprising each of said lenses of said first pair of lenses pivoting upwardly relative to said front of said frame.

11. The assembly of claim 2, further comprising a lens bridge coupled to and extending between each of said lenses of said first pair of lenses, said lens bridge being coupled to said frame bridge.

12. The assembly of claim 2, further comprising a pair of hinges, each of said hinges pivotally coupling a respective one of said lenses of said first pair of lenses to said lens bridge such that each of said lenses of said first pair of lenses is pivotable independently of each other.

13. The assembly of claim 12, further comprising each of said lenses of said first pair of lenses having an upper edge, a lower edge, an inner edge and an outer edge, each of said hinges being coupled to said respective lens of said first pair of lenses at a juncture between said upper edge and said inner edge of said respective lens of said first pair of lenses.

14. The assembly of claim 1, further comprising:
said front of said frame including a pair of rims and a frame bridge coupled to and extending between each of said rims, each of aid rims being spaced and aligned relative to each other, each of said rims being coupled to an associated one of said temples, each of said lenses of said first pair of lenses being positionable in front of an associated one of said rims; and
a second pair of lenses being coupled to said frame, each of said lenses of said second pair of lenses being positionable within an associated one of said rims, each of said lenses of said first pair of lenses being positionable in front of an associated one of said second pair of lenses such that said lenses of said first pair of lenses extend over and cover said lenses of said second pair of lenses.

15. An eyewear assembly with pivotal lenses comprising:
a frame, said frame including;
a pair of temples and a front, said front being coupled to and extending between said pair of temples, said front including;
a pair of rims being spaced and horizontally aligned relative to each other, each of said rims being coupled to an associated one of said temples, each of said rims having a respective break extending therethrough, each of said rims having a respective top section, inner side section and outer side section, each of said top sections being coupled to and extending between said associated inner and outer side sections, each of said outer side sections having a proximal end with respect to said associated top section, each of said inner side sections having a lower end with respect to said associated top section, each of said breaks extending between said proximal end and said lower end of said associated rim; and
a frame bridge coupled to and extending between each of said rims;
a first end piece and a second end piece, each of said first and second end pieces being coupled to and extending between an associated said rim and an associated said temple;
a lens assembly including a first pair of lenses, each of said lenses of said first pair of lenses being pivotally coupled to said front of said frame to allow said lenses of said first pair of lenses to be pivoted toward and away from said front of said frame, each of said lenses of said first pair of lenses pivoting upwardly relative to said front of said frame, each of said lenses of said first pair of lenses being removably coupled to said front of said frame whereby said lenses of said first pair of lenses are interchangeable, each of said lenses of said first pair of lenses being positionable within an associated one of said rims such that said associated rim extends at least partially around said respective lens of said first pair of lenses, each of said lenses of said first pair of lenses having an upper edge, a lower edge, an inner edge and an outer edge;
a lens bridge coupled to and extending between each of said lenses of said first pair of lenses, said lens bridge being coupled to said frame bridge;
a pair of hinges, each of said hinges pivotally coupling a respective one of said lenses of said first pair of lenses to said lens bridge such that each of said lenses of said first pair of lenses are pivotable independently of each other, each of said hinges being coupled to said respective lens of said first pair of lenses at a juncture between said upper edge and said inner edge of said respective lens of said first pair of lenses; and
a coupler releasably coupling said lens assembly to said front of said frame, said coupler releasably coupling said lens bridge to said frame bridge for attaching said lenses of said first pair of lenses to said frame, said coupler comprising a clip.

16. An eyewear assembly with pivotal lenses comprising:
a frame, said frame including;
a pair of temples and a front, said front being coupled to and extending between said pair of temples, said front including;
a pair of rims being spaced and horizontally aligned relative to each other, each of said rims being coupled to an associated one of said temples, each of said rims having a respective top section, inner side section and outer side section, each of said top sections being coupled to and extending between said associated inner and outer side sections, each of said outer side sections having a proximal end with respect to said associated top section, each of said inner side sections having a lower end with respect to said associated top section; and
a frame bridge coupled to and extending between each of said rims;
a first end piece and a second end piece, each of said first and second end pieces being coupled to and extending between an associated said rim and an associated said temple;
a lens assembly including a first pair of lenses, each of said lenses of said first pair of lenses being pivotally coupled to said front of said frame to allow said lenses of said first pair of lenses to be pivoted toward and away from said front of said frame, each of said lenses of said first pair of lenses pivoting upwardly relative to said front of said frame, each of said lenses of said first pair of lenses being removably coupled to said front of said frame whereby said lenses of said first pair of lenses are interchangeable, each of said lenses of said first pair of lenses being positionable in front of an associated one of said rims, each of said lenses of said first pair of lenses having an upper edge, a lower edge, an inner edge and an outer edge;
a second pair of lenses being coupled to said frame, each of said lenses of said second pair of lenses being positionable within an associated one of said rims, each of said lenses of said first pair of lenses being positionable in front of an associated one of said second pair of lenses such that said lenses of said first pair of lenses extend over and cover said lenses of said second pair of lenses;
a lens bridge coupled to and extending between each of said lenses of said first pair of lenses, said lens bridge being coupled to said frame bridge;
a pair of hinges, each of said hinges pivotally coupling a respective one of said lenses of said first pair of lenses to said lens bridge such that each of said lenses of said first pair of lenses are pivotable independently of each other, each of said hinges being coupled to said respective lens of said first pair of lenses at a juncture between said upper edge and said inner edge of said respective lens of said first pair of lenses; and
a coupler releasably coupling said lens assembly to said front of said frame, said coupler releasably coupling said lens bridge to said frame bridge for attaching said lenses of said first pair of lenses to said frame, said coupler comprising a clip.
